(19) United States
(12) Patent Application Publication
(10) Pub. No.: US 2009/0290527 A1
(43) Pub. Date: Nov. 26, 2009

(54) Automatic detection and cofiguration in wireless networks

(76) Inventors: Wey-Yi W. Guy, Beaverton, OR (US); Thomas A. Schultz, Hillsboro, OR (US)

Correspondence Address: INTEL CORPORATION;c/o CPA Global, P.O. BOX 52050, MINNEAPOLIS, MN, 55402, US

(21) Appl. No.: 12/462,214

(22) Filed: Jul. 31, 2009

Related U.S. Application Data
(63) Continuation of application No. 10/747,067, filed on Dec. 30, 2003.

(51) Int. Cl. H04B 7/14

(52) U.S. Cl. 370/315

(57) ABSTRACT

Automatic detection of access points and range extension points and automatic configuration may be used to eliminate a need for manual configuration.

### CROSS REFERENCE TO RELATED APPLICATIONS

This application is a continuation of U.S. patent application Ser. No. 10/747,067 filed Dec. 30, 2003, and claims priority to that filing date.

### BACKGROUND OF THE INVENTION

Mobile devices, such as mobile telephones, personal digital assistants (PDAs), portable (e.g., laptop) computers, and paging devices, have become ubiquitous in the world today. In our fast-paced society, we rely on such devices to give us greater flexibility in our daily lives, for business, family, and pleasure. With the proliferation of mobile network devices has come a proliferation of mobile wireless networks.

Many wireless networks may interface with fixed (wired) networks via access points (APs) that are root units (RUs). The RUs may generally be wired into the fixed networks and may communicate via wireless means with other elements of a wireless network. However, in general, an RU may only be able to be communicate with wireless network elements within its own signaling range.

The signaling range of an RU may be improved via the use of one or more APs that serve as RU range extenders (REs), which may communicate with at least one other AP (RU or other RE) and with other wireless network elements. An RE may act to relay communications between an AP and another wireless network element. A problem with the use of REs, however, is that they may result in a need for networks using them to be manually configured (that is, their topologies may need to be manually determined).

### BRIEF DESCRIPTION OF THE DRAWINGS

Preferred embodiments of the invention will now be described in connection with the associated drawings, in which:

FIG. 1 depicts a conceptual block diagram of a system implementing an embodiment of the invention;

FIG. 2 depicts a conceptual block diagram of a root range extender (RE) access point (AP) according to an embodiment of the invention;

FIG. 3 depicts a state diagram of a RE according to an embodiment of the invention;

FIG. 4 depicts a flowchart depicting a process according to an embodiment of the invention;

FIG. 5 depicts a conceptual diagram of an information element that may be used in an embodiment of the invention; and

FIG. 6 depicts an exemplary implementation of an embodiment of the invention.

### DETAILED DESCRIPTION OF PREFERRED EMBODIMENTS

In the following description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In the following description and claims, the terms “connected” and “coupled,” along with their derivatives, may be used. It should be understood that these terms are not intended as synonyms for each other. Rather, in particular embodiments, “connected” may be used to indicate that two or more elements are in direct physical or electrical contact with each other. In contrast, “coupled” may mean that two or more elements are in direct physical or electrical contact with each other or that the two or more elements are not in direct contact but still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

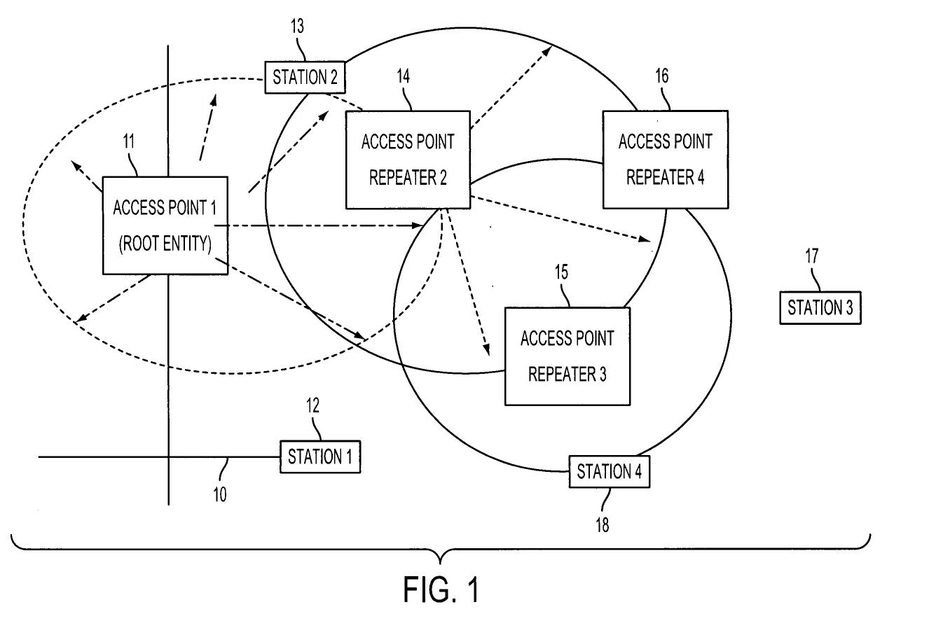

FIG. 1 depicts a system in which embodiments of the present invention may be implemented. In FIG. 1, the system may include an RU 11, which may, for example, be connected to a fixed network 10, through which RU 11 may communicate with other fixed stations 12 on fixed network 10. RU 11 may also communicate with wireless network elements, for example, 13, 14, via wireless communications.

The system may include among its wireless network elements REs, e.g., 14-16, and/or wireless stations, e.g., 13, 17, 18. Wireless stations 13, 17, 18 may include, but are not limited to, mobile telephones, mobile radios, portable computers, PDAs, paging devices, etc., and they may or may not be mobile.

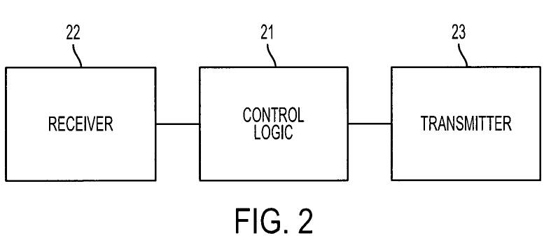

FIG. 2 shows a conceptual block diagram of a wireless network element (e.g., a wireless station or RE) according to an embodiment of the invention. The wireless network element may include a receiver 22 and a transmitter 23, as well as control logic 21. There may be multiple transmitters and/or receivers, as well. Control logic 21 may be implemented in the form of hardware, software, firmware, etc., or combinations thereof.

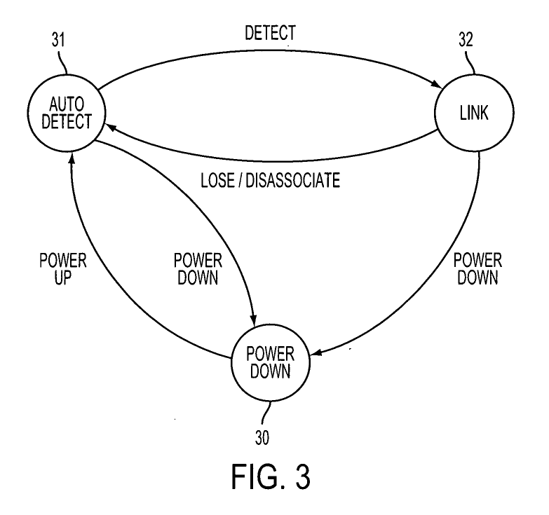

FIG. 3 depicts a state diagram that may represent the operation of control logic 21 according to an embodiment of the invention. Although this discussion will consider primarily the case of an RE, the state diagram of FIG. 3 may be applicable to either or both of REs and wireless stations, and/or other wireless network elements. The RE (or other network element) may begin in a power down state 30, in which it is not connected to the wireless network. When the RE powers up, it may first enter an auto detect state 31. In auto detect state 31, the RE may detect beacons transmitted from other wireless network elements (e.g., RUs or REs) and may choose a wireless network element corresponding to one of the detected beacons. The chosen beacon may correspond, for example, but is not limited to, a wireless network element that is the fewest number of hops (i.e., point-to-point transmission steps, representing a topological distance) from an RU, a wireless network element whose beacon has the greatest received signal strength, or some combination of these and/or other criteria. When a beacon is chosen, the RE may then associate itself with the corresponding wireless network element and establish a communication link between itself and that wireless network element. This causes the RE to enter the link state 32. In the link state, the RE may transmit its own beacon and may remain associated with the aforementioned wireless network element (in the case of a wireless station, a beacon may not be transmitted). Should the RE power down during either auto detect state 31 or link state 32, it may return to power down state 30. Furthermore, should the wireless network element with which the RE has associated power down, move out of communication range, or otherwise become unavailable, or should the RE be moved, the RE may disassociate from the wireless network element and may re-enter the auto detect state 31.

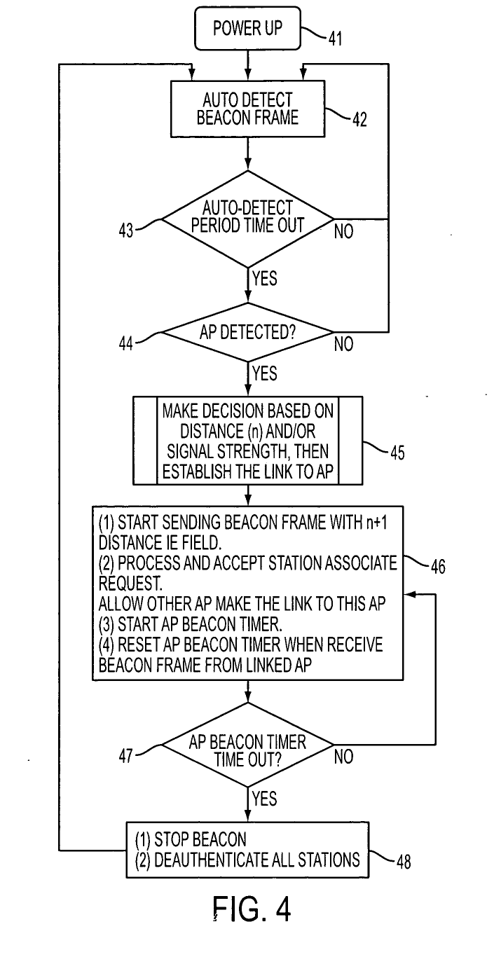

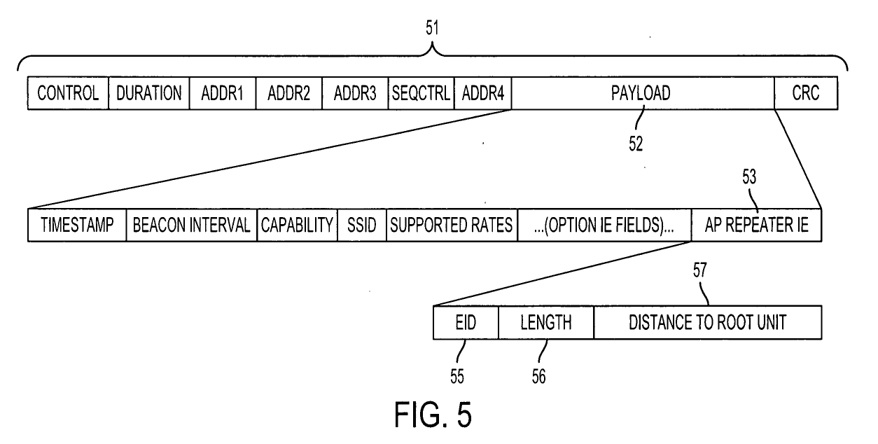

The process described in connection with the state diagram of FIG. 3 may be further explained in connection with the flowchart of FIG. 4. Upon power up, block 41, the RE may attempt to automatically detect at least one beacon frame, block 42, transmitted by one or more APs (RUs and/or REs); the beacon frame will be discussed below in further detail in conjunction with FIG. 5. The auto detection of block 42 may continue for a predetermined period, block 43. This may, alternatively, continue until at least one beacon frame is detected.

If the predetermined period has expired, block 43, then the process may continue to block 44 to determine if at least one beacon frame corresponding to at least one AP has been detected. If not, the process may loop back to block 42 to perform further detection. If at least one AP has been detected, the process may continue to block 45.

In block 45, the RE may decide among detected APs, as discussed above in connection with FIG. 3, based on such factors as number of hops, received signal strength, and combinations of these and/or other factors (but not limited thereto). As will be discussed below, the beacon frames may include information regarding number of hops. Upon deciding among the detected APs, the RE may then establish a communication link with the AP decided upon (the “chosen AP”).

In the case of a wireless station, the process of auto detection and configuration may be considered to be complete. In this case, as will be discussed in greater detail below in connection with an RE, the wireless station may remain associated with the chosen AP for as long as it continues to detect beacon frames. If no beacon frame is detected from the chosen AP for more than some predetermined time period, the wireless station may then disassociate itself from the chosen AP and may go back to block 42 and commence auto detection.

In the case of an RE, on the other hand, the process may continue with block 46. In block 46, the RE may begin transmitting its own beacon frame. In such a case, the RE may increment the number of hops in its own transmitted beacon frame, in comparison with the beacon frame received from the chosen AP. That is, if the chosen AP was n hops from an RU, the RE may transmit a beacon that indicates it is n+1 hops from an RU.

The RE may also form communication links with other wireless network elements (e.g., other REs and/or wireless stations) that may detect the RE and may seek to establish links with the RE as their AP.

Additionally, the RE may start an AP beacon timer. The chosen AP may continue to transmit its beacon frame, and the RE may continue to detect it. By so doing, the RE may ensure that the chosen AP is still available and that its communication link with the AP may continue to be maintained. The AP beacon timer may provide a “time-out” period during which, if a beacon frame is not received from the chosen AP, the RE may determine that the chosen AP has become unavailable, block 47. On the other hand, whenever a beacon frame is received from the chosen AP, the AP beacon timer may be reset, and a new period may begin.

If the AP beacon timer times out, block 47, the process may continue to block 48. In block 48, the RE may cease transmitting its beacon frame, e.g., to reflect the fact that it may no longer be an AP for the network. Accordingly, the RE may de-authenticate any wireless network elements that have established connections to the RE as an AP. The process may then loop back to block 42, and the RE may then re-commence auto detection.

As discussed above, embodiments of the invention may utilize a beacon frame containing certain information. An exemplary implementation of such a beacon frame is shown in FIG. 5. A beacon frame 51 may contain various control and address fields, for example, as well as a payload 52. Payload 52 may contain various fields, which may include, but which are not limited to, a time stamp, a beacon interval, a capability field, etc. In embodiments of the invention, in particular, payload 52 may comprise an information element (IE) 53 tailored to carry information useful in the above-described auto detect/auto configure process. In one particular implementation, IE 53 may comprise a unique identifier 55, a length field 56, which may contain a length of payload 52, and a network information field 57. Network information field 57 may include, but is not limited to, a distance, in terms of a number of hops from, an RU to a wireless network element transmitting the beacon frame. For example, an RU may transmit a beacon frame including a distance of zero, an RE connected to that RU may transmit a beacon frame containing a distance of one, and so on.

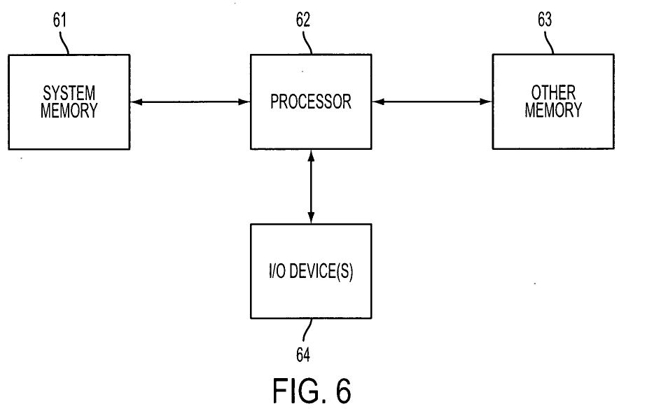

Some embodiments of the invention, as discussed above, may be embodied in the form of software instructions on a machine-readable medium. Such an embodiment is illustrated in FIG. 6. The computer system of FIG. 6 may include at least one processor 62, with associated system memory 61, which may store, for example, operating system software and the like. The system may further include additional memory 63, which may, for example, include software instructions to perform various applications. System memory 61 and additional memory 63 may be implemented as separate memory devices, they may be integrated into a single memory device, or they may be implemented as some combination of separate and integrated memory devices. The system may also include one or more input/output (I/O) devices 64, for example (but not limited to), keyboard, mouse, trackball, printer, display, network connection, etc. The present invention may be embodied as software instructions that may be stored in system memory 61 or in additional memory 63. Such software instructions may also be stored in removable media (for example (but not limited to), compact disks, floppy disks, etc.), which may be read through an I/O device 64 (for example, but not limited to, a floppy disk drive). Furthermore, the software instructions may also be transmitted to the computer system via an I/O device 64, for example, a network connection; in this case, the signal containing the software instructions may be considered to be a machine-readable medium.

The invention has been described in detail with respect to various embodiments, and it will now be apparent from the foregoing to those skilled in the art that changes and modifications may be made without departing from the invention in its broader aspects. The invention, therefore, as defined in the appended claims, is intended to cover all such changes and modifications as fall within the true spirit of the invention.

What is claimed is:

1. A method of performing operations in a first access point, the operations comprising:
detecting a first beacon transmitted from a second access point, wherein the second access point is either a wired root unit or has established a first communication link with a wired root unit;
establishing, subsequent to said detecting, a second communication link with the second access point;
transmitting a second beacon, wherein the second beacon can be received by one or more wireless stations; and
associating, subsequent to said transmitting, with the one or more wireless stations; and
disassociating, subsequent to said associating, from the one or more wireless stations.

2. The method according to claim 1, wherein said second beacon includes an indication of a number of hops from the wired root unit to the first access point.

3. The method according to claim 1, further comprising receiving a response from a third access point in response to the second beacon.

4. The method according to claim 1, further comprising:
detecting a third beacon transmitted from a third access point prior to said transmitting the second beacon; and
not establishing a third communication link with the third access point.

5. The method according to claim 1, further comprising:
starting a timer corresponding to a predetermined period of time; and
checking for detection of another beacon from the second access point before expiration of the timer.

6. The method according to claim 5, further comprising performing said disassociating in response to not detecting said another beacon before said expiration of the timer.

7. An apparatus containing a first access point, the first access point comprising a memory, a transmitter, and a receiver, each coupled to a processor, the apparatus to:
detect a first beacon transmitted from a second access point;
establish a second communication link with the second access point subsequent to said detection of the first beacon;
transmit a second beacon, wherein the second beacon can be received by one or more wireless stations;
associate with the one or more wireless stations in response to receiving responses from the one or more wireless stations; and
disassociate from the one or more wireless stations subsequent to said association.

8. The apparatus according to claim 7, wherein the first access point is further to receive a response from a third access point in response to the second beacon.

9. The apparatus according to claim 7, wherein the first access point is further to:
detect a third beacon transmitted from a third access point prior to said transmitting the second beacon; and
not establish a third communication link with the third access point in preference to said establishment of the second communication link with the second access point.

10. The apparatus of claim 7, wherein the first access point is further to:
start a timer corresponding to a predetermined period of time after said detection of the first beacon; and
check for detection of another beacon from the second access point before expiration of the timer.

11. The apparatus of claim 10, further comprising performing said disassociation in response to not detecting said another beacon before said expiration of the timer.

12. The apparatus of claim 7, wherein the second access point is either a wired root unit or has established a first communication link with a wired root unit.

13. A machine-readable medium that provides instructions, which when executed by a computing platform, cause said computing platform to perform operations in a first access point, the operations comprising:
detecting a first beacon transmitted from a second access point, wherein the second access point is either a wired root unit or has established a first communication link with a wired root unit;
establishing, subsequent to said detecting, a second communication link with the second access point;
transmitting a second beacon, wherein the second beacon can be received by one or more wireless stations; and
associating, subsequent to said transmitting, with the one or more wireless stations; and
disassociating, subsequent to said associating, from the one or more wireless stations.

14. The medium according to claim 13, wherein said second beacon includes an indication of a number of hops from the wired root unit to the first access point.

15. The medium according to claim 13, wherein the operations further comprise receiving a response from a third access point in response to the second beacon.

16. The medium according to claim 13, wherein the operations further comprise:
detecting a third beacon transmitted from a third access point prior to said transmitting the second beacon; and
not establishing a third communication link with the third access point.

17. The medium according to claim 13 wherein the operations further comprise:
starting a timer corresponding to a predetermined period of time; and
checking for detection of another beacon from the second access point before expiration of the timer.

18. The medium according to claim 17, wherein the operations further comprise performing said disassociating in response to not detecting said another beacon before said expiration of the timer.
